(19) United States
(12) Patent Application Publication
(10) Pub. No.: US 2011/0125490 A1
(43) Pub. Date: May 26, 2011

(54) NOISE SUPPRESSOR AND VOICE DECODER

(76) Inventors: Satoru Furuta, Tokyo (JP); Hirohisa Tasaki, Tokyo (JP)

(21) Appl. No.: 13/055,837

(22) PCT Filed: Oct. 24, 2008
(86) PCT No.: PCT/JP2008/003021

§ 371 Date: Jan. 25, 2011

(51) Int. Cl. G10L 21/02; H04B 15/00

(52) U.S. Cl. 704/205; 381/94.1; 704/226; 704/E21.002

(57) ABSTRACT

A processed component calculating unit 14 obtains a transformed noise suppressed spectrum 18a based on the ratio between a noise suppressed spectrum 18 and an estimated noise spectrum 17, and a phase disturbing unit 15 performs phase disturbance to obtain a processed spectrum 19 consisting of smoothed components that make deterioration components in the noise suppressed spectrum 18 subjectively imperceptible. A signal addition unit 11 adds the processed spectrum 19 to the frequency components of the noise suppressed spectrum 18 deteriorated through the noise suppression of a noise suppressing unit 3 to suppress the deterioration components.

### TECHNICAL FIELD

The present invention relates to a noise suppressor for suppressing noise mixed into a voice/acoustic signal and to a voice decoder with the noise suppressor.

### BACKGROUND ART

As a typical method of noise suppression for emphasizing an intended signal, a voice signal or the like, by suppressing noise, an unintended signal, from an input signal into which noise is mixed, an SS (Spectral Subtraction) method has been known, for example. The SS method carries out noise suppression by subtracting from an amplitude spectrum an average noise spectrum estimated separately (see Non-Patent Document 1, for example).

When noise suppression such as an SS method has been performed, estimated errors of the noise spectrum remain in the signal after the noise suppression as distortions which give characteristics very different from the signal before the processing and appear as harsh noise (also called artificial noise or musical tone), thereby sometimes deteriorating subjective quality of the output signal greatly.

In addition, increasing a compression ratio of a voice/acoustic encoding scheme such as voice and musical sounds results in a gradual increase of quantization noise at encoding and spectral distortion involved in code modeling. Thus, the subjective quality of the output signal deteriorates greatly. In particular, when noise is mixed into a voice/acoustic signal or when an input signal includes only noise, since a voice model the encoding scheme employs differs greatly from a background noise model, the deterioration becomes marked. Incidentally, a deterioration feeling in a background noise section is like water current sounds such as a “hiss”, which is sometimes called water flow noise.

As a conventional method of suppressing the foregoing subjective deterioration feeling, there is one disclosed in Patent Document 1, for example.

A sound signal processing method of the Patent Document 1 aims at reducing in an acoustic feeling a distortion feeling, which occurs owing to noise suppression or low bit rate voice encoding. It tries to improve the subjective quality mainly in a section including a lot of deterioration components such as background noise by performing weighted addition of the input signal and a processed signal obtained by smoothing the input signal according to an estimated value of a noise ratio in a signal obtained by a voice/noise state discriminating means.
Non-Patent Document 1: Steven F. Boll “Suppression of Acoustic noise in speech using spectral subtraction”, IEEE Trans. ASSP, Vol. ASSP-27, No. 2, April 1979.
Patent Document 1: Japanese Patent Laid-Open No. 2004-272292 (pp. 14-16 and FIG. 4).

With the foregoing configuration, because the weighted addition control of the input signal and processed signal depends on the voice/noise state discriminating means, the conventional noise suppressor has a problem of causing, when carrying out processing in a section including voice because of a failure of detecting a voice section, marked quality deterioration due to occurrence of an echo feeling (reverberation feeling) or noise feeling.

Incidentally, in the conventional noise suppressor, to reduce the influence of an interval decision error, an improvement means of employing an interval decision evaluation value of a continuous quantity has been mentioned. However, since the evaluation value itself is based on an analysis result in a time domain, it is a fixed value in a frequency domain. Accordingly, as for a voice signal into which car noise whose noise power concentrates upon a low-frequency range is mixed, the following problems can arise. When the threshold of the evaluation value is adjusted in such a manner as to suppress the deterioration feeling of the noise in the low-frequency range, the voice signal in a high-frequency range with power relatively greater than the noise signal can be erroneously processed, which brings about quality deterioration. In contrast, when the adjustment is made in such a manner as to prevent the distortion of the voice signal in the high-frequency range from appearing, a problem arises in that improvement is scarcely obtained.

In addition, although the conventional noise suppressor controls the weighted addition for the individual frequency components in the spectral domain, the control factor is limited to only the magnitude of the amplitude spectral components of the input signal without a decision as to whether the individual frequency components are voice or noise. In the final analysis, whether the input signal is voice (or musical sound) depends greatly on the interval decision evaluation value in the time domain, and hence if an erroneous interval decision is made, the condition of causing the quality deterioration is unchanged.

The present invention is implemented to solve the foregoing problems. Therefore it is an object of the present invention to provide a noise suppressor capable of performing noise suppression desirable for an acoustic feeling and of keeping quality deterioration to a minimum even in a high noise condition, and to provide a high-quality voice decoder with the noise suppressor.

### DISCLOSURE OF THE INVENTION

A noise suppressor in accordance with the present invention includes: a time-frequency transform unit for transforming an input signal to an input signal spectrum composed of frequency components; a noise spectrum estimating unit for estimating an estimated noise spectrum from the input signal; a noise spectrum suppressing unit for performing noise suppression of the input signal spectrum according to the estimated noise spectrum and for generating a noise suppressed spectrum; a signal transform unit for generating a processed spectrum by transforming and smoothing the noise suppressed spectrum in accordance with a ratio based on the noise suppressed spectrum and the estimated noise spectrum; and a signal addition unit for suppressing deterioration components included in the noise suppressed spectrum by adding the processed spectrum to the noise suppressed spectrum.

This offers an advantage of being able to prevent the echo feeling and noise feeling due to an interval decision error from occurring, and to improve subjective quality for the individual spectral components.

In addition, a voice decoder in accordance with the present invention includes: a voice decoding unit for generating a decoded signal by decoding given code data; a time-frequency transform unit for transforming the decoded signal to a decoded signal spectrum composed of frequency components; a noise spectrum estimating unit for estimating an estimated noise spectrum from the decoded signal; a signal transform unit for generating a processed spectrum by transforming and smoothing the decoded signal spectrum in accordance with a ratio based on the decoded signal spectrum and the estimated noise spectrum; and a signal addition unit for suppressing deterioration components included in the decoded signal spectrum by adding the processed spectrum to the decoded signal spectrum.

This offers an advantage of being able to prevent the echo feeling and noise feeling due to the interval decision error from occurring, and to improve subjective quality for the individual spectral components.

### BRIEF DESCRIPTION OF THE DRAWINGS

FIG. 1 is a diagram showing a whole configuration of a noise suppressor of an embodiment 1 in accordance with the present invention;

FIG. 2 is an operation diagram showing a series of processing contents in a signal processing unit described in the embodiment 1 in accordance with the present invention, which shows an amplitude spectrum and a phase spectrum at a particular frequency in a vector form;

FIG. 3 is a graph explaining a series of processing in the signal processing unit described in the embodiment 1 in accordance with the present invention, which shows a spectrum in a typical case;

FIG. 4(a) is an operation diagram showing a series of processing contents in the signal processing unit described in the embodiment 1 in accordance with the present invention, which shows an amplitude spectrum and a phase spectrum at a frequency in a domain B of FIG. 3 in a vector form;

FIG. 4(b) is an operation diagram showing a series of processing contents in the signal processing unit described in the embodiment 1 in accordance with the present invention, which shows an amplitude spectrum and a phase spectrum at a frequency in a domain C of FIG. 3 in a vector form;

FIG. 5 is a diagram showing a whole configuration of a noise suppressor of an embodiment 2 in accordance with the present invention;

FIG. 6 is an operation diagram showing a series of processing contents in a signal processing unit described in the embodiment 2 in accordance with the present invention, which shows an amplitude spectrum and a phase spectrum at a particular frequency in a vector form;

FIG. 7 is a diagram showing a whole configuration of a noise suppressor of an embodiment 4 in accordance with the present invention;

FIG. 8 is a diagram showing a whole configuration of a voice decoder of an embodiment 5 in accordance with the present invention;

FIG. 9 is a diagram showing a whole configuration of a voice decoder of an embodiment 6 in accordance with the present invention;

FIG. 10 is a diagram showing a whole configuration of a noise suppressor of an embodiment 8 in accordance with the present invention;

FIG. 11 is a diagram showing a whole configuration of a voice decoder of an embodiment 9 in accordance with the present; and

FIG. 12 is a diagram showing a whole configuration of a voice decoder of an embodiment 10 in accordance with the present invention.

### BEST MODE FOR CARRYING OUT THE INVENTION

The best mode for carrying out the invention will now be described with reference to the accompanying drawings to explain the present invention in more detail.

### Embodiment 1

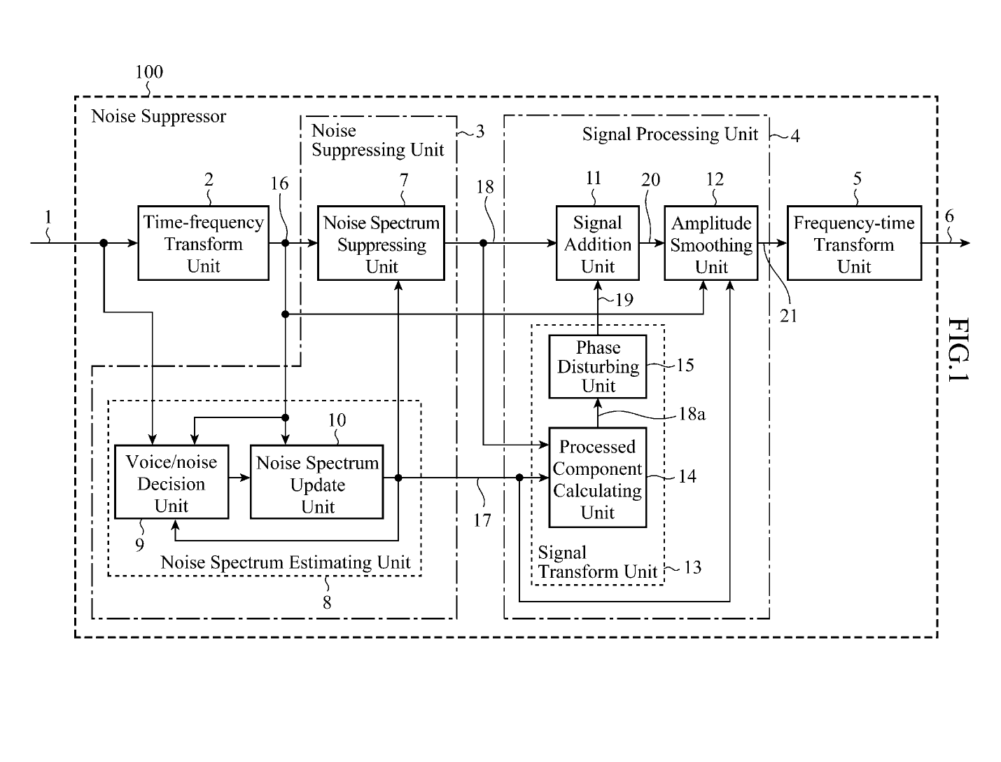

FIG. 1 is a diagram showing a whole configuration of a noise suppressor 100 of the present embodiment.

The noise suppressor 100 shown in FIG. 1 comprises a time-frequency transform unit 2, a noise suppressing unit 3, a signal processing unit 4, and a frequency-time transform unit 5. The noise suppressing unit 3 comprises a noise spectrum suppressing unit 7 and a noise spectrum estimating unit 8 including a voice/noise decision unit 9 and a noise spectrum update unit 10. The signal processing unit 4 comprises a signal addition unit 11, an amplitude smoothing unit 12, and a signal transform unit 13 including a processed component calculating unit 14 and a phase disturbing unit 15.

The operation principle of the noise suppressor 100 will be described below with reference to FIG. 1.

First, an input signal 1, which is sampled at a prescribed sampling frequency (8 kHz, for example) and is divided into frames with a prescribed frame period (20 msec, for example), is supplied to the time-frequency transform unit 2 in the noise suppressor 100 and to the voice/noise decision unit 9 in the noise spectrum estimating unit 8 which will be described later.

The time-frequency transform unit 2 applies windowing to the input signal 1 split into the frame period, and transforms the signal after the windowing into an input signal spectrum 16 consisting of spectral components for the individual frequencies using a 256-point FFT (Fast Fourier Transform), for example. The time-frequency transform unit 2 supplies the input signal spectrum 16 to the noise spectrum suppressing unit 7 and the noise spectrum estimating unit 8 in the noise suppressing unit 3 and to the amplitude smoothing unit 12 in the signal processing unit 4. As for the windowing, a well-known technique such as a Hanning window and trapezoid window can be employed. As for the FFT, since it is a widely known technique, its description will be omitted.

In the noise suppressing unit 3, the noise spectrum suppressing unit 7 performs noise suppression on the input signal spectrum 16 supplied from the time-frequency transform unit 2 using an estimated noise spectrum 17 supplied from the noise spectrum estimating unit 8 which will be described later, and supplies the result obtained to the signal addition unit 11 and the processed component calculating unit 14 in the signal processing unit 4 as a noise suppressed spectrum 18.

Here, as a technique of the noise suppression in the noise spectrum suppressing unit 7, it is possible to employ the following techniques, for example: one based on the spectrum subtraction described in Non-Patent Document 1; a well-known method such as spectrum amplitude suppression that gives attenuation to the individual spectral components according to the signal-to-noise ratio (SN ratio) at the individual frequencies of the input signal spectrum 16 and estimated noise spectrum 17; and a technique combining the spectrum subtraction with the spectrum amplitude suppression (such as a method described in Japanese Patent No. 3454190 “noise suppressing apparatus and method”).

The signal processing unit 4 carries out processing of deterioration components in the noise suppressed spectrum 18 in such a manner as to improve the acoustic feeling according to the mode of the noise suppressed spectrum 18 which is the input signal spectrum after the noise suppression and the mode of the estimated noise spectrum 17. More specifically, using the noise suppressed spectrum 18 the noise spectrum suppressing unit 7 outputs and the estimated noise spectrum 17 the noise spectrum estimating unit 8 outputs, the signal transform unit 13 generates a processed spectrum 19, and the signal addition unit 11 adds the processed spectrum 19 to the noise spectrum 18 to make an addition spectrum 20. Then the amplitude smoothing unit 12 smoothes the addition spectrum 20 in the time direction and frequency direction, and supplies to the frequency-time transform unit 5 as a smoothed noise suppressed spectrum 21 that undergoes the smoothing processing desirable for the acoustic feeling. As for the processing of the signal processing unit 4, it will be described later in more detail.

The frequency-time transform unit 5 applies inverse FFT processing to the smoothed noise suppressed spectrum 21 supplied from the signal processing unit 4 to return it to a time domain signal, carries out concatenation while performing windowing for smooth connection with the previous and subsequent frames, and outputs the resultant signal as an output signal 6.

The noise spectrum estimating unit 8 estimates the average noise spectrum in the input signal 1. First, the voice/noise decision unit 9 computes a voice-like signal VAD using the input signal 1, the input signal spectrum 16 the time-frequency transform unit 2 outputs, and the estimated noise spectrum 17 estimated from a past frame. The voice-like signal VAD indicates the degree of the input signal 1 in the current frame as to whether it is more like voice or noise. For example, it is a signal that takes a large evaluation value when there is a high probability that it is voice, and that takes a small evaluation value when the probability of voice is low.

The voice/noise decision unit 9 can employ as the calculation method of the voice-like signal VAD the maximum value of autocorrelation analysis of the input signal 1 and a frame SN ratio that can be calculated from the ratio between the power of the input signal 1 and the power of the estimated noise spectrum 17 singly or in combination. Here, the maximum value ACFₘₐₓ of the autocorrelation analysis result of the input signal 1 is given by Expression (1) and the frame SN ratio SNR_{fr} is given by Expression (2), respectively.

$$\begin{matrix}{ACF}_{max} = {{max}_{j = 0}}^{N} ( \frac{{\sum }_{t = 0}^{N - k} x ( t ) x ( t + j )}{{\sum }_{t = 0}^{N} {( x ( t ) )}^{2}} , 0 ) & ( 1 ) \\ {SNR}_{fr} = max \{ 20 {log}_{10} ( {\sum }_{k = 0}^{M} S ( k ) ) - 20 {log}_{10} ( {\sum }_{k = 0}^{M} N ( k ) ) , 0 \} & ( 2 )\end{matrix}$$

Here, x(t) is the input signal 1 split into a frame at time t, N is an autocorrelation analysis section length, S(k) is a k-th component of the input signal spectrum 16, N(k) is a k-th component of the estimated noise spectrum 17 and M is the number of the FFT points.

From the maximum value ACFₘₐₓ of the autocorrelation analysis obtained by the foregoing Expression (1) and the frame SN ratio SNR_{fr} obtained by Expression (2), the voice-like signal VAD can be calculated by the following Expression (3).

VAD=w_{ACF}·ACFₘₐₓ+w_{SNR}·SNR_{fr}·SNRₙₒᵣₘ (3)

Here, SNRₙₒᵣₘ is a prescribed value for normalizing the value SNR_{fr} in the range of 0-1, and w_{ACF} and w_{SNR} are prescribed values for weighting. They can be each adjusted in advance in such a manner that the voice-like signal VAD can be decided appropriately in accordance with the type of noise and the power of the noise. Incidentally, ACFₘₐₓ takes a value in the range of 0-1 according to the property of the foregoing Expression (1). The voice/noise decision unit 9 supplies the noise spectrum update unit 10 with the voice-like signal VAD for the noise spectrum estimation, which is calculated by the processing described above.

In addition, setting the value of either w_{ACF} or w_{SNR} at zero in the foregoing Expression (3) makes it possible to calculate the voice-like signal VAD using only the parameter set at nonzero. More specifically, when w_{SNR} is set at zero, the voice-like signal VAD is obtained using only the maximum value ACFₘₐₓ of the autocorrelation analysis.

On the other hand, at the calculation of the voice-like signal VAD, it is possible to add an analysis parameter other than the indicators/values shown in the foregoing Expression (3). For example, it is possible to add various improvements and modifications in such a manner that the voice/noise decision unit 9 calculates the SN ratios of the spectral components for the individual frequencies using the input signal spectrum 16 and estimated noise spectrum 17, and utilizes the sum of the SN ratios of the spectral components for the individual frequencies (the possibility of voice increases with an increase of the sum) or the variance of the SN ratios for the individual frequencies (the possibility of voice increases as the variance increases in which case the harmonic structure of the voice appears stronger).

Referring to the voice-like signal VAD which is the output of the voice/noise decision unit 9, the noise spectrum update unit 10 updates, when the possibility is high that the mode of the input signal 1 of the current frame is noise, the estimated noise spectrum 17 estimated from past frames stored in the internal memory or the like by using the input signal spectrum 16 of the current frame. For example, according to the next Expression (4), the noise spectrum update unit 10 carries out the update by reflecting the input signal spectrum 16 on the estimated noise spectrum 17.

Ñ(n,k)=(1−α(k))·N(n−1,k)+α(k)·Sₙₒᵢₛₑ(n,k) (4)

where
k=0, . . . , M

Here, n is a frame number, N(n−1,k) is the estimated noise spectrum 17 before the update, Sₙₒᵢₛₑ (n,k) is the input signal spectrum 16 of the current frame as to which a decision is made that the possibility of noise is high, and Ntilde(n,k) (considering the electronic filing, an alphabetical letter with a diacritic (˜) mark is denoted by alphabet tilde) is the estimated noise spectrum 17 after the update. In addition, α(k) is a prescribed update speed coefficient taking a value of 0-1 which is preferably set at a value comparatively close to zero. Furthermore, there are some cases where it is better to gradually increase the coefficient value α(k) as the frequency increases. It is also possible to adjust it in accordance with the type of noise.

Thus, the noise spectrum update unit 10 performs updating by calculating the right-hand side of Expression (4) and by making the Ntilde(n,k) on the left-hand side the new estimated noise spectrum 17. The noise spectrum update unit 10 supplies the estimated noise spectrum 17 obtained to the noise spectrum suppressing unit 7, voice/noise decision unit 9, processed component calculating unit 14 and amplitude smoothing unit 12 described before. Here, the estimated noise spectrum 17 supplied to the voice/noise decision unit 9 is used in the voice-like evaluation of the next frame.

Incidentally, as for the update method of the estimated noise spectrum 17, to further improve the estimation accuracy and estimation follow-up ability, various modifications and improvements are possible such as using a plurality of update speed coefficients in accordance with the values of the voice-like signal VAD; referring to the changes in the input signal power or estimated noise power between the frames, and using the update speed coefficient that can speedup the update speed if the changes are great; or replacing (resetting) the estimated noise spectrum 17 by the input signal spectrum 16 of the frame with the minimum power or with the minimum voice-like signal VAD. In addition, when the value of the voice-like signal VAD is sufficiently large, that is, when the probability that the input signal 1 of the current frame is voice is high, the noise spectrum update unit 10 need not perform the update of the estimated noise spectrum 17.

Next, the signal processing unit 4 will be described. The signal transform unit 13 generates the processed spectrum 19 using the noise suppressed spectrum 18 the noise spectrum suppressing unit 7 generates and the estimated noise spectrum 17 the noise spectrum estimating unit 8 generates. First, the processed component calculating unit 14 obtains, for the individual frequency components of the estimated noise spectrum 17, values that are calculated by multiplying their amplitudes by a prescribed value (a transformed estimated noise spectrum which will be described later); transforms the noise suppressed spectrum 18 in such a manner that it has the same amplitudes as the products obtained; and supplies to the phase disturbing unit 15 as a transformed noise suppressed spectrum 18a. Incidentally, as the prescribed value by which the estimated noise spectrum 17 is multiplied, a value in a neighborhood of the maximum suppression amount in the noise suppression is suitable. For example, when the maximum suppression amount is −12 dB, it is desirable for the prescribed value to be about 0.25-0.2, and adjusted in advance according to the type of the noise, the noise suppression method, the degree of the deterioration or the liking of the user. In addition, it is also possible to hold a plurality of values in the memory or the like, and causes the processed component calculating unit 14 to switch to an appropriate value in accordance with the type of the noise and the noise power.

The phase disturbing unit 15 carries out phase disturbance as a kind of smoothing. As for the transformed noise suppressed spectrum 18a calculated by the processed component calculating unit 14, the phase disturbing unit 15 gives disturbance to the phase component of its individual frequencies, and supplies the spectrum after the disturbance to the signal addition unit 11 as the processed spectrum 19. As a method of giving disturbance to individual phase components, it is desirable to generate phase angles within a prescribed range using random numbers and to add them to the original phase angles. When no limits are set to the range for generating the phase angles, the phase disturbing unit 15 can replace the individual phase components by the values generated from random numbers.

Incidentally, as for the limits for the phase angle generating range, the phase disturbing unit 15 can control the phase angle generating range adaptively in such a manner that when the noise power is very large and the deterioration of the noise suppressed spectrum 18 is large, no limits for the range are set; or that when the noise power or SN ratio reduces in accordance with the magnitude of the noise power or the SN ratios of the spectrum for the individual frequencies, the range is increased. In addition, as for the limits to the disturbance range, the phase disturbing unit 15 can assign weights in the frequency axis direction in such a manner as to increase the range of the disturbance as the frequency increases, or to stop the phase disturbance in the low-frequency range.

The signal addition unit 11 suppresses the deterioration components in the noise suppressed spectrum 18 by adding the processed spectrum 19 to the noise suppressed spectrum 18, and supplies the resultant addition spectrum 20 to the amplitude smoothing unit 12.

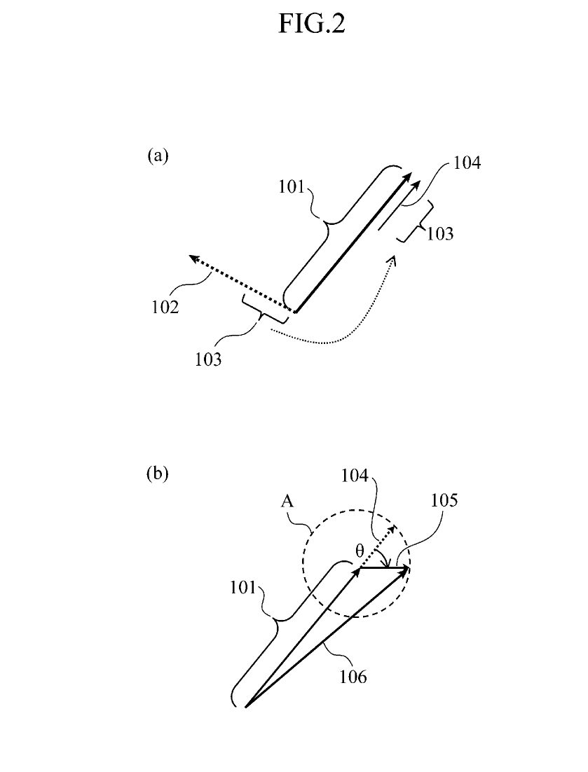

FIG. 2 is an operation diagram showing a series of processing contents in the signal transform unit 13 and signal addition unit 11, which expresses in vectors an amplitude spectrum and a phase spectrum at a particular frequency.

FIG. 2(a) is a diagram showing relation between the noise suppressed spectrum 18 and the estimated noise spectrum 17, which expresses a vector 101 of the noise suppressed spectrum 18, a vector 102 of the estimated noise spectrum 17, a scalar value 103 resulting from multiplying the amplitude of the estimated noise spectrum 17 by a prescribed value, and a vector 104 of the transformed noise suppressed spectrum 18a resulting from transforming the vector 101 in such a manner as to have the same amplitude value as the scalar value 103.

In addition, FIG. 2(b) is a diagram showing relation between the noise suppressed spectrum 18, processed spectrum 19 and addition spectrum 20, which expresses the vector 101 of the noise suppressed spectrum 18, the vector 104 of the transformed noise suppressed spectrum 18a, a vector 105 of the processed spectrum 19 obtained by applying the phase disturbance to the transformed noise suppressed spectrum 18a, and a vector 106 of the addition spectrum 20. Besides, θ is a phase angle for applying the phase disturbance to the vector 104. A range of the phase disturbance (existing range of the processed spectrum 19) A is shown by a dotted circle.

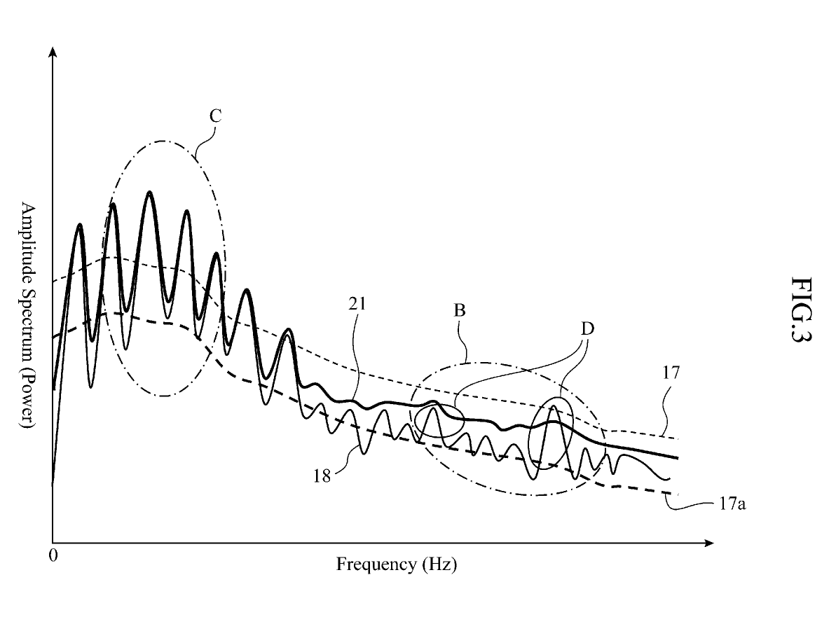

FIG. 3 is a graph illustrating a series of processing of the signal transform unit 13 and signal addition unit 11, which shows spectra in a typical case. In FIG. 3, the vertical axis shows the power of the amplitude spectrum and the horizontal axis shows frequency. Dotted lines represent the estimated noise spectrum 17 and the transformed estimated noise spectrum 17a undergoing transformation of multiplying the estimated noise spectrum 17 by a prescribed positive value less than one, and solid lines represent the noise suppressed spectrum 18 and smoothed noise suppressed spectrum 21. In addition, a domain B of a dash dotted circle represents an example in which the amplitude of the transformed estimated noise spectrum 17a is close to the amplitude of the noise suppressed spectrum 18, and the domain C of a dash dotted circle represents an example in which the amplitude of the transformed estimated noise spectrum 17a is smaller than the amplitude of the noise suppressed spectrum 18. Incidentally, the transformed estimated noise spectrum 17a of FIG. 3 corresponds to the scalar value 103 obtained by multiplying the amplitude of the estimated noise spectrum 17 of FIG. 2 by a prescribed value.

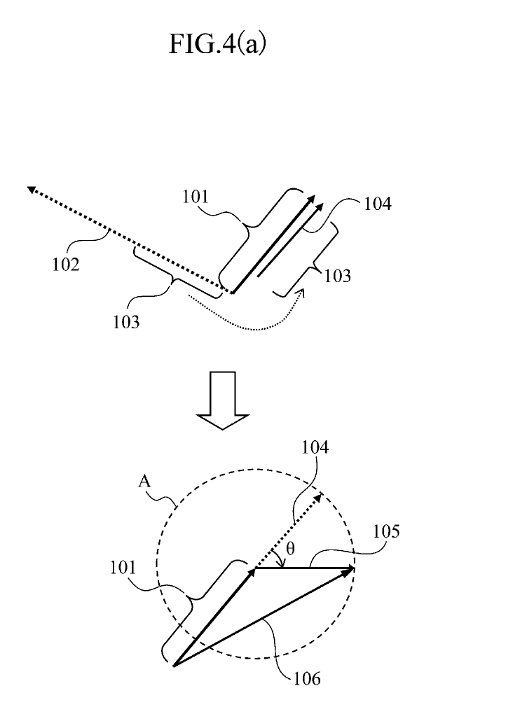

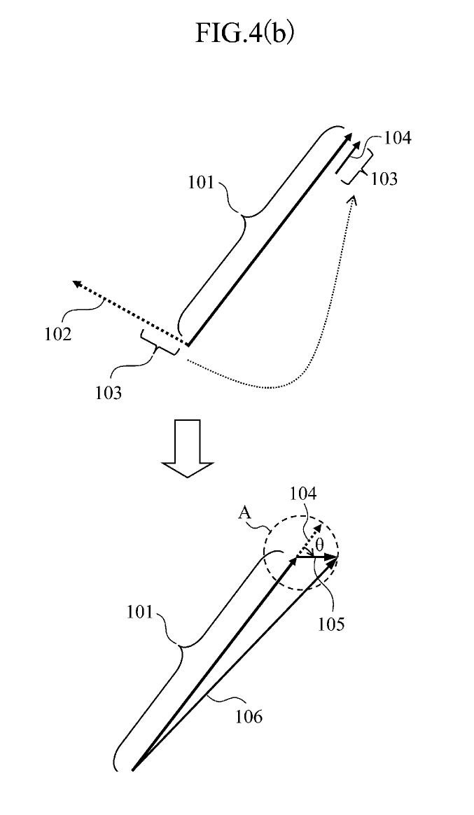

FIG. 4 is an operation diagram showing a series of processing contents of the signal transform unit 13 and signal addition unit 11 for the domains B and C of FIG. 3: FIG. 4(a) expresses the amplitude spectrum and phase spectrum at a frequency in the domain B of FIG. 3 invectors; and FIG. 4(b) expresses the amplitude spectrum and phase spectrum at a frequency in the domain C of FIG. 3 invectors. Incidentally, FIG. 4 assigns the same reference numerals to the same components as those of FIG. 2.

As shown in FIG. 4(a), when the amplitude of the transformed estimated noise spectrum 17a (corresponding to the scalar value 103) is close to the amplitude of the noise suppressed spectrum 18 (corresponding to the vector 101), since the prescribed value by which the estimated noise spectrum 17 is multiplied is set at the maximum suppression amount neighborhood, the spectral component of the noise suppressed spectrum 18 can be considered to have passed through the noise suppression using the suppression amount close to the maximum suppression amount. In other words, the spectral component represents that it is noise. In this case, as shown in domain B of FIG. 3, it is highly probable that the noise suppressed spectrum 18 has noise left which cannot be suppressed completely in the noise suppression (particularly in the high-frequency range, that is, as the frequency increases). Thus, the residual noise D which is a deterioration component in the noise suppressed spectrum 18 will undergo greater signal processing by the processed spectrum 19.

On the other hand, as shown in FIG. 4(b), when the amplitude of the transformed estimated noise spectrum 17a is smaller than the amplitude of the noise suppressed spectrum 18, there is a strong likelihood that the spectral component of the noise suppressed spectrum 18 is voice. However, since the noise suppressed spectrum 18 is superior as shown by the domain C of FIG. 3, the influence of the signal processing by the processed spectrum 19 is small, and there is little effect on the acoustic feeling.

Let us return to the explanation of the operation principle of the noise suppressor 100. The amplitude smoothing unit 12 shown in FIG. 1 performs smoothing processing of the amplitude components of the individual frequencies of the addition spectrum 20 supplied from the signal addition unit 11, and supplies the smoothed spectrum to the frequency-time transform unit 5 as the smoothed noise suppressed spectrum 21. Here, the smoothing processing can use one of the frequency axis direction and time axis direction (inter-frame smoothing) or a combination of both of them. As a desirable example in the present embodiment, the amplitude smoothing unit 12 can perform the smoothing processing in both the frequency axis and time axis as shown in the following Expressions (5) and (6).

X(n,0)=S_{ADD}(n,0)

X(n,k)=(1−β(k))·S_{ADD}(n,k−1)+β(k)·S_{ADD}(n,k)

where, k=1, . . . , M (5)

Y(n,k)=(1−γ(k))·Y(n−1,k)+γ(k)·X(n,k)

where, k=0, . . . , M (6)

Here, the foregoing Expression (5) shows the smoothing processing in the frequency axis direction, and Expression (6) shows the smoothing processing in the time axis direction; and n is the frame number, k is the spectral component number, S_{ADD}(n,k) is the addition spectrum 20, X(n,k) is the addition spectrum after smoothing in the frequency axis direction, and Y(n,k) is the addition spectrum after smoothing in both the frequency axis and time axis, that is, the smoothed noise suppressed spectrum 21. Besides, β(k) and γ(k) are smoothing coefficients in the frequency axis direction and time axis direction, respectively, which are prescribed values having a value 0-1. As for the smoothing coefficients β(k) and γ(k), although their optimum values vary in accordance with the frame length and the degree of the deterioration in sounds to be eliminated, desirable values are about 0.95 and 0.2-0.4, respectively, in the present embodiment. In addition, according to the type of noise, it is better to assign weights to the smoothing coefficient in the frequency direction. For example, as for car noise having large power in the low-frequency range, adjustment is desirable which strengthens smoothing in the low-frequency range, and as for noise in a middle to high frequency range such as wind noise and turbine noise which sound like a high-pitched ringing, adjustment is possible which strengthens smoothing in the frequency direction of that band but weakens smoothing in the time axis direction of the band, thereby being able to increase the effect of the smoothing by specializing according to noise types.

Furthermore, in the foregoing amplitude smoothing processing, the amplitude smoothing unit 12 can alter or control the smoothing processing method, or alter the smoothing coefficient, for example, in accordance with the input signal spectrum 16 and estimated noise spectrum 17. In the present embodiment, using the SN ratios at individual frequencies of the input signal spectrum 16 and estimated noise spectrum 17 (spectral SN ratios between the input signal spectrum 16 as S and the estimated noise spectrum 17 as N), the amplitude smoothing unit 12 carries out the smoothing in both the frequency axis direction and time axis direction when the spectral SN ratios are less than 0.75 dB, performs the smoothing only in the time axis direction when the spectral SN ratios are not less than 0.75 dB and less than 1.5 dB, and halts the smoothing processing when the spectral SN ratios are 1.5 dB and more, for example, which results in good quality of the output voice 6. In addition, the amplitude smoothing unit 12 can employ the noise suppressed spectrum 18 instead of the input signal spectrum 16. Since the ratio between the noise suppressed spectrum 18 and the estimated noise spectrum 17 can be a good indicator of the residual noise as described before in the explanation of FIG. 3, the amplitude smoothing unit 12 can operate the smoothing processing more efficiently, thereby being able to achieve further subjective quality improvement.

In addition, to a degree that has no effect on the voice signal (1 dB in amplitude, for example), the amplitude smoothing unit 12 can superpose, on the spectral components after the smoothing processing, pseudo-noise such as noise with Hoth spectrum characteristics, Brown noise, or noise obtained by providing white noise with frequency characteristics (like a slope) of the noise spectrum in the input signal.

According to the present embodiment 1, the noise suppressor 100 is configured in such a manner as to comprise the time-frequency transform unit 2 for transforming the input signal 1 to the input signal spectrum 16 consisting of the frequency components; the noise spectrum estimating unit 8 for estimating the estimated noise spectrum 17 from the input signal 1; the noise spectrum suppressing unit 7 for performing the noise suppression of the input signal spectrum 16 according to the estimated noise spectrum 17 to generate the noise suppressed spectrum 18; the signal transform unit 13 for generating the processed spectrum 19 by transforming the noise suppressed spectrum 18 in accordance with the ratio based on the noise suppressed spectrum 18 and estimated noise spectrum 17 followed by smoothing (phase disturbing) the noise suppressed spectrum 18; and the suppressing signal addition unit 11 for adding the processed spectrum 19 to the noise suppressed spectrum 18 to suppress the deterioration components contained in the noise suppressed spectrum 18.

Therefore when the signal processing unit 4 performs the prescribed processing on the noise suppressed spectrum 18 deteriorated through the noise suppression and the like, it obtains, from the frequency component values of the noise suppressed spectrum 18 and the frequency component values of the estimated noise spectrum 17, the processed spectrum 19 which is the smoothed components in which the deterioration components contained in the noise suppressed spectrum 18 are processed in such a manner as to be not subjectively perceived, and adds the processed spectrum 19 to the frequency components of the noise suppressed spectrum 18, thereby being able to suppress the deterioration components. As a result, it can obviate the need for the voice/noise interval decision which is necessary in the conventional method, offering an advantage of being able to improve the subjective quality without the echo feeling or noise feeling due to the interval decision error.

In addition, the signal processing unit 4 is configured in such a manner as to perform the generation and processing of the smooth processed components for the individual spectral components in the frequency domain. Accordingly, as for the voice signal into which car noise is mixed which has the noise power concentrated in the low-frequency range, for example, it can process the deterioration components, which can subjectively improve the deterioration feeling of the noise in the low-frequency range without applying any processing to the voice components in the high-frequency range, thereby offering an advantage of being able to further improve the subjective quality.

In addition, the signal processing unit 4 is configured in such a manner as to generate the processed components for the individual spectral components from both the noise suppressed spectrum 18 corresponding to the input signal and the estimated noise spectrum 17. Accordingly, it can perform the processing control corresponding to the individual spectral components. For example, it offers an advantage of being able to improve the subjective quality of the signal having deterioration components generated locally in a particular band.

In addition, the signal processing unit 4 is configured in such a manner as to perform as its processing the smoothing of the amplitude spectral components and the disturbance of the phase spectral components. Accordingly, as to the artificial amplitude components and phase components the deterioration components have, it can suppress unstable behavior of the components suitably and provide the disturbance to them, thereby offering an advantage of being able to further improve the subjective quality.

Incidentally, although the foregoing embodiment 1 is configured in such a manner that the processing performed on the noise suppressed spectrum 18 is carried out by both the phase disturbing unit 15 and amplitude smoothing unit 12, a configuration is also possible in which the noise suppressor 100 comprises only the phase disturbing unit 15, for example, and performs only one of the processing such as the phase disturbance processing.

In addition, although the foregoing embodiment 1 employs the voice/noise decision unit 9 and noise spectrum update unit 10 to estimate the estimated noise spectrum 17, means for obtaining the noise spectrum are not limited to the configuration. For example, a method can also be employed which obviates the voice/noise decision unit 9 by greatly reducing the update speed of the noise spectrum, or which does not carry out the estimation by the estimated noise spectrum 17 from the input signal 1, but performs the analysis/estimation separately from the input signal used for the noise estimation, to which only noise is input.

### Embodiment 2

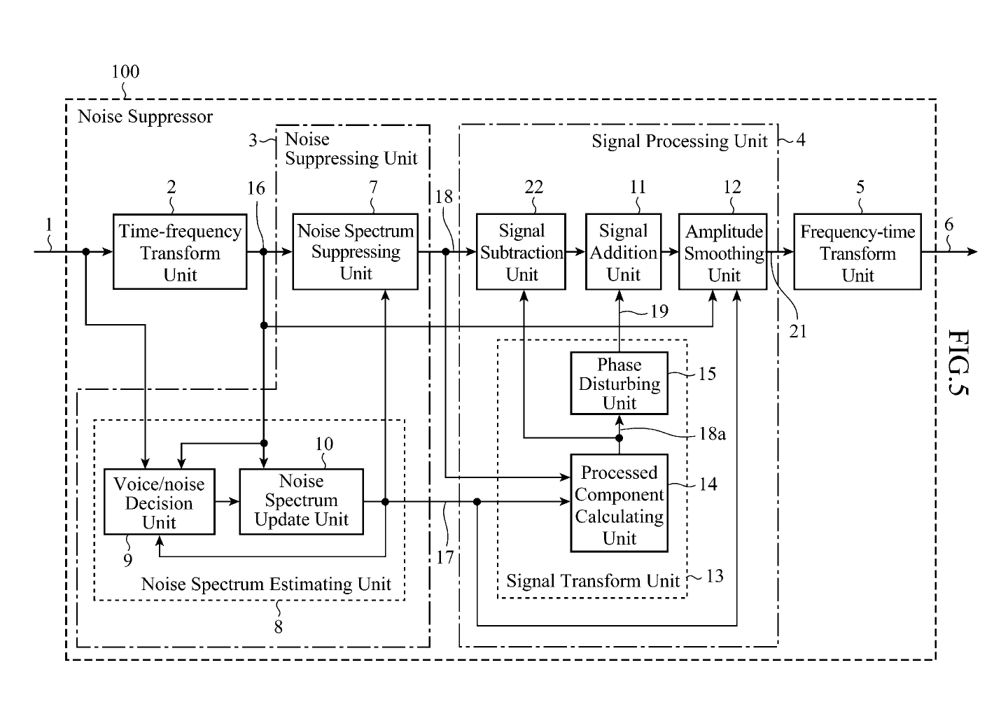

FIG. 5 is a diagram showing an overall configuration of the noise suppressor 100 of the present embodiment, which adds a signal subtraction unit 22 to the noise suppressor 100 of the foregoing embodiment 1. In the description of the following embodiments, the same or like components to those of the previously described embodiment 1 (FIG. 1) are designated by the same reference numerals and their description will be omitted.

The processed component calculating unit 14 obtains values (a transformed estimated noise spectrum) for the individual frequency components of the estimated noise spectrum 17 by multiplying its amplitudes by a prescribed value, transforms the noise suppressed spectrum 18 for the individual frequency components in such a manner that it has the same amplitudes as the transformed estimated noise spectrum, and supplies to the phase disturbing unit 15 and signal subtraction unit 22 as the transformed noise suppressed spectrum 18a. Incidentally, as for the prescribed value by which the estimated noise spectrum 17 is multiplied, it can be adjusted in advance in accordance with the type of the noise, noise suppression method, degree of deteriorated sounds or the liking of a user in the same manner as in the embodiment 1.

The signal subtraction unit 22 subtracts the transformed noise suppressed spectrum 18a from the noise suppressed spectrum 18 the noise spectrum suppressing unit 7 outputs, and supplies the resultant spectral components to the signal addition unit 11.

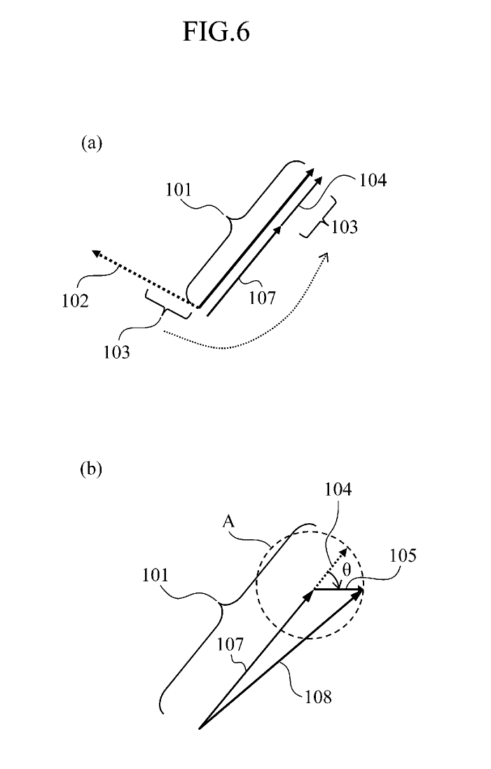

FIG. 6 is an operation diagram showing a series of processing contents in the signal transform unit 13, signal subtraction unit 22 and signal addition unit 11, which expresses in vectors an amplitude spectrum and phase spectrum at a particular frequency. In FIG. 6, the same or like components to those of FIG. 2 are designated by the same reference numerals and their description will be omitted.

FIG. 6(a) is a diagram, as FIG. 2(a), showing relation between the noise suppressed spectrum 18 and the estimated noise spectrum 17, which expresses the vector 101 of the noise suppressed spectrum 18, the vector 102 of the estimated noise spectrum 17, the scalar value 103 resulting from multiplying the amplitude of the estimated noise spectrum 17 by a prescribed value, the vector 104 of the transformed noise suppressed spectrum 18a, and a component vector 107 of the spectrum resulting from subtracting the transformed noise suppressed spectrum 18a from the noise suppressed spectrum 18.

In addition, FIG. 6(b) is a diagram, as FIG. 2(b), showing an example of the relation between the noise suppressed spectrum, the processed spectrum obtained in FIG. 6(a) and the addition spectrum, which expresses the vector 101 of the noise suppressed spectrum 18, the vector 104 of the transformed noise suppressed spectrum 18a, the vector 105 of the processed spectrum 19, a component vector 107 of the spectrum resulting from subtracting the transformed noise suppressed spectrum 18a from the noise suppressed spectrum 18, and a vector 108 of the addition spectrum 20.

FIG. 6 differs from FIG. 2 in that before adding the vector 105 of the processed spectrum 19 to the vector 101 of the noise suppressed spectrum 18, the vector 104 of the transformed noise suppressed spectrum 18a is subtracted. This offers an advantage of being able to prevent the amplitude of the noise suppressed spectrum 18 from increasing even if the signal addition unit 11 adds the processed spectrum 19 for suppressing the deterioration components.

As in the foregoing embodiment 1, the amplitude smoothing unit 12 performs the amplitude smoothing processing on the addition spectrum 20. In addition, to a degree that has no effect on the voice signal (1 dB in amplitude, for example), the amplitude smoothing unit 12 can superpose, on the spectral components after the smoothing processing, pseudo-noise such as noise with Hoth spectrum characteristics, Brown noise, or noise obtained by providing white noise with frequency characteristics (like a slope) of the noise spectrum in the input signal.

According to the present embodiment 2, the noise suppressor 100 is configured in such a manner as to comprise the signal transform unit 13 for generating the transformed noise suppressed spectrum 18a by transforming the noise suppressed spectrum 18 in accordance with the ratio based on the noise suppressed spectrum 18 and the estimated noise spectrum 17 and for generating the processed spectrum 19 passing through the smoothing (phase disturbing) of the transformed noise suppressed spectrum 18a; the signal subtraction unit 22 for subtracting the transformed noise suppressed spectrum 18a from the noise suppressed spectrum 18; and the signal addition unit 11 for suppressing the deterioration components contained in the noise suppressed spectrum 18 by adding the processed spectrum 19 to the noise suppressed spectrum 18 from which the transformed noise suppressed spectrum 18a is subtracted by the signal subtraction unit 22.

Since it is configured in such a manner that the signal processing unit 4 subtracts the transformed noise suppressed spectrum 18a from the noise suppressed spectrum 18 and then adds the processed spectrum 19, it offers besides the advantages of the foregoing embodiment 1 an advantage of being able to further improve the subjective quality while suppressing the noise feeling of the output signal 6.

Incidentally, as shown in FIG. 5, although the foregoing embodiment 2 carries out the addition processing of the signal addition unit 11 after the subtraction processing of the signal subtraction unit 22, it goes without saying that the order can be reversed. In other words, it can subtract the transformed noise suppressed spectrum 18a after adding the processed spectrum 19 to the noise suppressed spectrum 18, offering the same advantage.

In addition, although the foregoing embodiment 2 has a configuration in which the noise suppressor 100 includes the amplitude smoothing unit 12, a configuration is also possible which removes the amplitude smoothing unit 12 and omits the amplitude smoothing processing.

In addition, although the foregoing embodiment 2 employs the voice/noise decision unit 9 and noise spectrum update unit 10 for estimating the estimated noise spectrum 17, a means for obtaining the noise spectrum is not limited to the configuration as in the foregoing embodiment 1. For example, a method can also be employed which obviates the voice/noise decision unit 9 by greatly reducing the update speed of the noise spectrum, or which does not carry out the estimation of the estimated noise spectrum 17 from the input signal 1, but performs the analysis/estimation separately from the input signal used for the noise estimation, to which only noise is input.

### Embodiment 3

The foregoing embodiments 1 and 2 have a configuration that employs, in the processing of the processed component calculating unit 14 in the signal transform unit 13, a value in the neighborhood of the maximum suppression amount in the noise suppression as the prescribed value to be multiplied for the individual frequencies of the estimated noise spectrum 17. As for the prescribed value to be multiplied for the individual frequencies of the estimated noise spectrum 17, the present embodiment has a configuration of weighting in the frequency axis direction such as assigning a large value to a low frequency and a small value to a high frequency. A configuration of the noise suppressor of the present embodiment is the same in a drawing as the configuration of the noise suppressor 100 of the foregoing embodiment 1 shown in FIG. 1 or that of the embodiment 2 shown in FIG. 5, and differs only in the processing of the processed component calculating unit 14.

Incidentally, as for the weighting coefficients to be used for the frequency weighting, the processed component calculating unit 14 can selects them from one or more tables (which are an array of constants when described in a program) in accordance with the type of noise or the liking of a user. Alternatively, it can define a function in advance which takes in a spectrum slope that can be calculated from the noise power or from the ratio between the low-frequency component power and the high-frequency component power of the estimated noise spectrum 17 and which generates and outputs the weighting coefficients, and can generate them from the function for each frame to be successively applied.

According to the present embodiment 3, the processed component calculating unit 14 assigns in the frequency direction weights to the prescribed values to be multiplied for the individual frequencies of the estimated noise spectrum 17. Accordingly, in addition to the advantages described in the foregoing embodiments 1 and 2, it offers an advantage of being able to improve the subjective quality for the signal whose degree of deterioration varies in the frequency direction.

### Embodiment 4

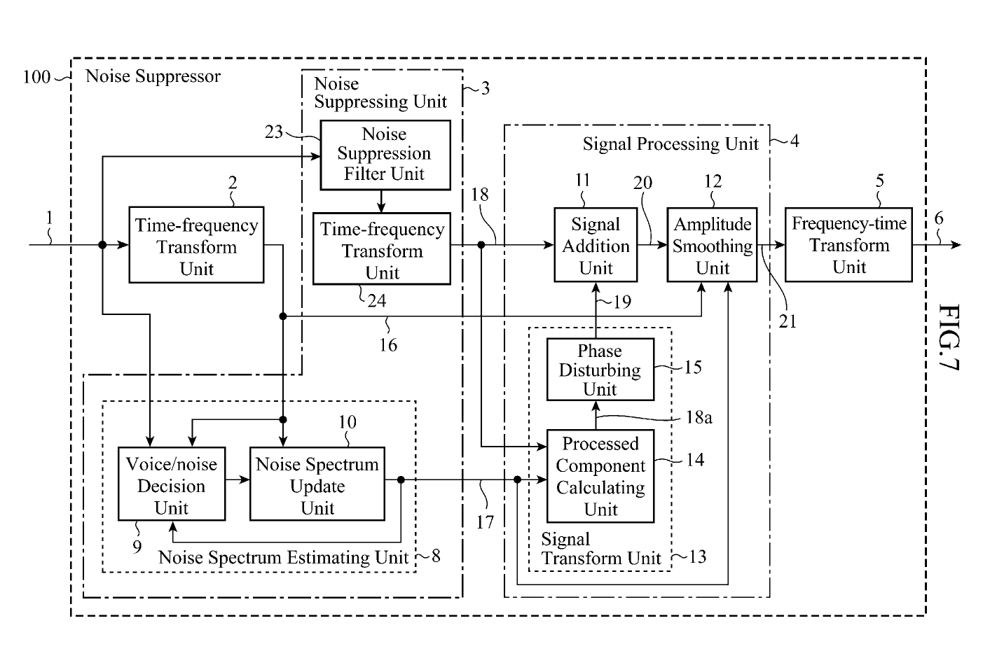

Although the foregoing embodiment 1 carries out the noise suppression in the frequency domain (also referred to as a “spectral domain”), the configuration is not essential, and it can be carried out in the time domain. FIG. 7 is a diagram showing an overall configuration of the noise suppressor 100 in the present embodiment. It has a configuration comprising a noise suppression filter unit 23 and a time-frequency transform unit 24 instead of the noise spectrum suppressing unit 7 of the foregoing embodiment 1. In the description of the following embodiments, the same or like components to those of the previously described embodiment 1 (FIG. 1) are designated by the same reference numerals and their description will be omitted.

The noise suppression filter unit 23 shown in FIG. 7 takes in the input signal 1 and performs noise suppression in the time domain. To be concrete, the noise suppression filter unit 23 performs on the input signal 1 the noise suppression corresponding to the time axis processing such as a Kalman filter, and supplies to the time-frequency transform unit 24 as a noise suppressed signal.

The time-frequency transform unit 24 transforms the noise suppressed signal the noise suppression filter unit 23 produces to a frequency domain signal. To be concrete, the time-frequency transform, unit 24 performs FFT of the noise suppressed signal, and supplies the resultant spectral components to the signal addition unit 11 and processed component calculating unit 14 as the noise suppressed spectrum 18. Incidentally, it is desirable for the number of FFT points of the time-frequency transform unit 24 to be equal to the number of FFT points of the time-frequency transform unit 2. Thus, when the time-frequency transform unit 24 outputs the noise suppressed spectrum 18, it is better for the number of FFT points to be adjusted to that of the time-frequency transform unit 2. More specifically, the time-frequency transform unit 24 can, for example, thin out or average and output the spectral components when its number of FFT points is greater than the number of FFT points of the time-frequency transform unit 2, and can interpolate and output the spectral components when it is less than that. However, it is not essential that the numbers of FFT points of the time-frequency transform units 2 and 24 are the same.

According to the present embodiment 4, it offers an advantage of being able to improve the subjective quality of the target signal to be processed regardless of the noise suppression technique such as in the frequency domain or time domain.

Incidentally, the configuration of the foregoing embodiment 4 is easily applicable to the foregoing embodiments 2 and 3, and these configurations can also offer an advantage of being able to improve the subjective quality of the target signal to be processed regardless of the noise suppression technique such as in the frequency domain or time domain.

### Embodiment 5

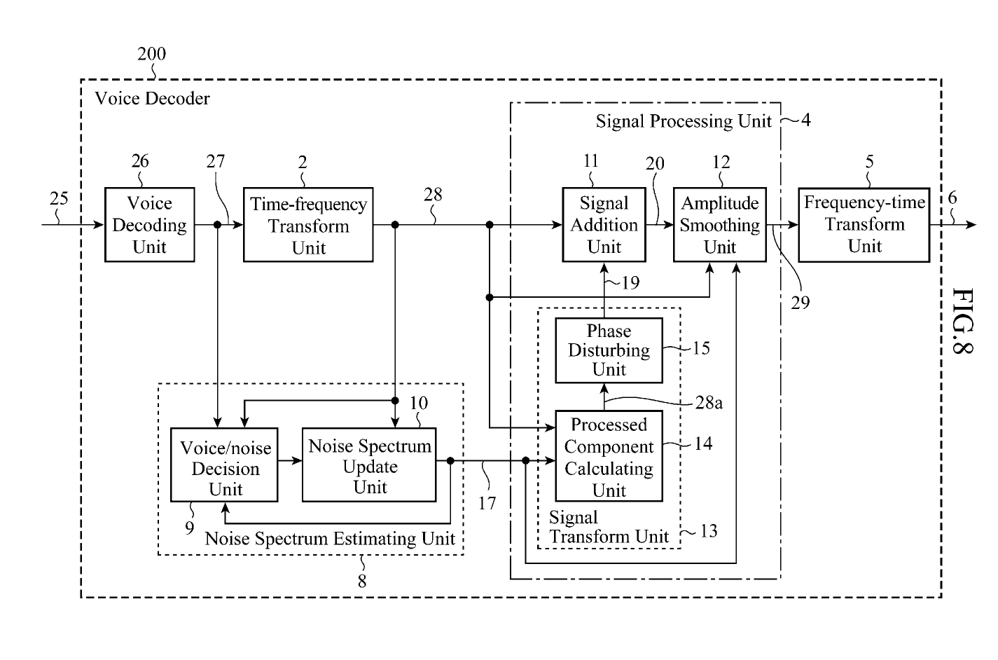

The noise suppressor 100 of the embodiment 1 can be modified to construct a voice decoder 200 shown in the present embodiment. FIG. 8 shows an overall configuration of the voice decoder 200 of the present embodiment. The voice decoder 200 receives code data 25 instead of the input signal, and it has a voice decoding unit 26 for decoding the code data 25 newly. In FIG. 8, the same or like components to those of FIG. 1 are designated by the same reference numerals.

First, the code data 25 is input to the voice decoding unit 26 in the voice decoder 200 via a wire or wireless communication channel not shown or via a storage means like a memory. Incidentally, the code data 25 is a result of encoding a voice/acoustic signal by a voice encoding unit not shown.

The voice decoding unit 26 performs prescribed decoding of the code data 25, which corresponds to the encoding of the voice encoding unit, and supplies the decoded signal 27 to the time-frequency transform unit 2 and voice/noise decision unit 9.

The time-frequency transform unit 2 applies frame splitting and windowing to the decoded signal 27 instead of the input signal 1 as in the foregoing embodiment 1, and performs FFT, for example, on the signal after the windowing. Then, the time-frequency transform unit 2 supplies a decoded signal spectrum 28 consisting of the spectral components of the individual frequencies to the signal processing unit 4 and noise spectrum estimating unit 8.

In the noise spectrum estimating unit 8, the voice/noise decision unit 9 calculates the voice-like signal in the current frame by using the decoded signal 27 and the decoded signal spectrum 28, first. Subsequently, the noise spectrum update unit 10 estimates the average noise spectrum in the decoded signal spectrum 28 and produces as the estimated noise spectrum 17. Incidentally, as for the configuration and each processing in the noise spectrum estimating unit 8, those similar to those of the foregoing embodiment 1 can be used.

The signal transform unit 13 in the signal processing unit 4 generates the processed spectrum 19 by using the decoded signal spectrum 28 and the estimated noise spectrum 17 supplied from the noise spectrum estimating unit 8. First, the processed component calculating unit 14 obtains, for the individual frequency components of the estimated noise spectrum 17, values resulting from multiplying their amplitudes by a prescribed value, transforms the decoded signal spectrum 28 for the individual frequency components in such a manner as to have the same amplitudes as the products obtained, and supplies to the phase disturbing unit 15 as a transformed decoded signal spectrum 28a. Incidentally, being different from the embodiment 1, the present embodiment does not perform the noise suppression. Accordingly, as for the prescribed value by which the estimated noise spectrum 17 is multiplied, it is not a value in the neighborhood of the maximum suppression amount, but a value equal to one or slightly less than one can be used, for example. Alternatively, a value can also be used which is adjusted in advance in accordance with the voice encoding method, the degree of deterioration of the decoded signal 27 or the liking of a user. In addition, it is also possible to store a plurality of values in a memory and to switch by the processed component calculating unit 14 to a suitable value in accordance with the type of the voice encoding method and the like.

As for the transformed decoded signal spectrum 28a calculated by the processed component calculating unit 14, the phase disturbing unit 15 gives disturbance to its phase components for the individual frequencies, and supplies the spectrum after the disturbance to the signal addition unit 11 as the processed spectrum 19. As to the method of giving the disturbance to the individual phase components and the control method of the phase disturbance range, the same methods as those of embodiment 1 can be used.

The signal addition unit 11 adds the processed spectrum 19 to the decoded signal spectrum 28, and supplies the resultant addition spectrum 20 to the amplitude smoothing unit 12.

The amplitude smoothing unit 12 performs on the addition spectrum 20 supplied from the signal addition unit 11 the smoothing processing of the amplitude components of the spectrum for the individual frequencies, and supplies the smoothed spectrum to the frequency-time transform unit 5 as a smoothed decoded signal spectrum 29. Incidentally, as for the configuration of the amplitude smoothing unit 12, its processing and smoothing control method, those similar to those of the embodiment 1 can be used. As for the individual parameters, they can be adjusted in advance in accordance with the voice encoding method or the degree of deterioration of the decoded signal 27, for example.

In addition, to a degree that has no effect on the voice signal (1 dB in amplitude, for example), the amplitude smoothing unit 12 can superpose, on the spectral components after the smoothing processing, artificially generated pseudo-noise such as noise with Hoth spectrum characteristics, Brown noise, or noise obtained by providing white noise with frequency characteristics (like a slope) of the noise spectrum in the input signal.

The frequency-time transform unit 5 performs the inverse FFT processing on the smoothed decoded signal spectrum 29 supplied from the signal processing unit 4 to return it to a time domain signal, carries out concatenation while performing windowing for smooth connection with previous and following frames, and supplies the resultant signal to the output signal 6.

According to the present embodiment 5, the voice decoder 200 is configured in such a manner as to comprise the voice decoding unit 26 for generating the decoded signal 27 by decoding the given code data 25; the time-frequency transform unit 2 for transforming the decoded signal 27 to the decoded signal spectrum 28 consisting of the frequency components; the noise spectrum estimating unit 8 for estimating the estimated noise spectrum 17 from the decoded signal 27; the signal transform unit 13 for generating the processed spectrum 19 by transforming the decoded signal spectrum 28 in accordance with the ratio based on the decoded signal spectrum 28 and estimated noise spectrum 17 followed by smoothing (phase disturbing) the decoded signal spectrum 28; and the signal addition unit 11 for adding the processed spectrum 19 to the decoded signal spectrum 28 to suppress the deterioration components contained in the decoded signal spectrum 28.

Accordingly, when the signal processing unit 4 performs the prescribed processing on the decoded signal spectrum 28 deteriorated through the voice encoding, it obtains the processed spectrum 19 consisting of the smoothed components obtained by making the deterioration components in the decoded signal spectrum 28 subjectively imperceptible according to the frequency component values of the decoded signal spectrum 28 and according to the frequency component values of the estimated noise spectrum 17, and adds the processed spectrum 19 to the frequency components of the decoded signal spectrum 28, thereby being able to suppress the deterioration components. Accordingly, the voice/noise interval decision, which is necessary in the conventional method, becomes unnecessary. As a result, it offers an advantage of being able to improve the subjective quality without the echo feeling or noise feeling due to the interval decision error.

In addition, the signal processing unit 4 is configured in such a manner as to perform generation and processing of the smooth processed components for the individual spectral components in the frequency domain. Accordingly, even for the voice signal into which the car noise whose noise power is concentrated in the low-frequency range is mixed, for example, since it can perform the suppression processing of the deterioration components without processing the voice components in the high-frequency range while subjectively improving the deterioration feeling of the noise in the low-frequency range, it offers an advantage of being able to further improve the subjective quality.

In addition, the signal processing unit 4 is configured in such a manner as to generate the processed components for the individual spectral components from both the decoded signal spectrum 28 which is the input signal and the estimated noise spectrum 17. Accordingly, it can perform the processing control in accordance with the individual spectral components. For example, it offers an advantage of being able to improve the subjective quality even for the signal with the deterioration components occurring locally in a particular band.

In addition, as the processing of the signal processing unit 4, it is configured in such a manner as to smooth the amplitude spectral components and to disturb the phase spectral components. Accordingly, as for the artificial amplitude components and phase components the deterioration components have, it can appropriately suppress unstable behavior of the components and provide disturbance, thereby offering an advantage of being able to further improve the subjective quality.

Incidentally, although the foregoing embodiment 5 is configured in such a manner as to perform the processing on the decoded signal spectrum 28 by both the phase disturbing unit 15 and amplitude smoothing unit 12, a configuration is also possible which carries out one of the processing in such a manner that the voice decoder 200 has only the phase disturbing unit 15 to perform only the phase disturbance processing.

In addition, although the foregoing embodiment 5 employs the voice/noise decision unit 9 and noise spectrum update unit 10 for estimating the estimated noise spectrum 17, a means for obtaining the noise spectrum is not limited to the configuration as in the foregoing embodiment 1. For example, a method can also be employed which obviates the voice/noise decision unit 9 by greatly reducing the update speed of the noise spectrum, or which does not carry out the estimation of the estimated noise spectrum 17 from the decoded signal 27, but performs the analysis/estimation separately from the input signal for the noise estimation, to which only noise is input.

### Embodiment 6

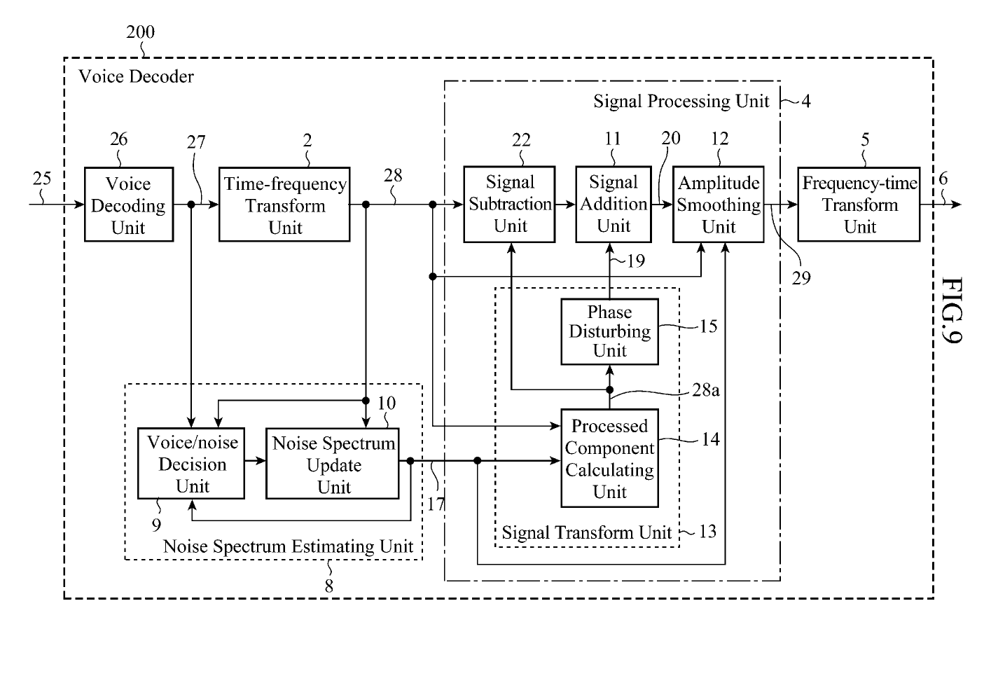

As the foregoing embodiment 5, a voice decoder 200 as shown in the present embodiment can be configured by modifying the noise suppressor 100 of the foregoing embodiment 2. FIG. 9 shows an overall configuration of the voice decoder 200 of the present embodiment. In FIG. 9, the same or like components to those of FIG. 5 or FIG. 8 are designated by the same reference numerals and their description will be omitted.

The processed component calculating unit 14 obtains, for the individual frequency components of the estimated noise spectrum 17, values resulting from multiplying their amplitudes by a prescribed value, transforms the decoded signal spectrum 28 for the individual frequency components in such a manner as to have the same amplitudes as the products obtained, and supplies not only to the phase disturbing unit 15 but also to the signal subtraction unit 22 as a transformed decoded signal spectrum 28a. Incidentally, as for the prescribed value by which the estimated noise spectrum 17 is multiplied, a value can be used, for example, which is set at one or slightly less than one, or which is adjusted in advance in accordance with the voice encoding method, the degree of deterioration of the decoded signal 27 or the liking of a user as in the foregoing embodiment 5. In addition, it is also possible to store a plurality of values in a memory and to switch by the processed component calculating unit 14 to a suitable value in accordance with the type of the voice encoding method and the like.

The signal subtraction unit 22 performs subtraction processing of subtracting the transformed decoded signal spectrum 28a from the decoded signal spectrum 28 the time-frequency transform unit 2 outputs, and supplies the resultant spectral components to the signal addition unit 11.

The amplitude smoothing unit 12 performs the amplitude smoothing processing on the addition spectrum 20 as in the foregoing embodiment 5. In addition, to a degree that has no effect on the voice signal (1 dB in amplitude, for example), the amplitude smoothing unit 12 can superpose, on the spectral components after the smoothing processing, artificially generated pseudo-noise such as noise with Hoth spectrum characteristics, Brown noise, or noise obtained by providing white noise with frequency characteristics (like a slope) of the noise spectrum in the input signal.

According to the present embodiment 6, the voice decoder 200 is configured in such a manner as to comprise the signal transform unit 13 for generating the transformed decoded signal spectrum 28a by transforming the decoded signal spectrum 28 in accordance with the ratio based on the decoded signal spectrum 28 and the estimated noise spectrum 17 and for generating the processed spectrum 19 by smoothing (phase disturbing) the transformed decoded signal spectrum 28a; the signal subtraction unit 22 for subtracting the transformed decoded signal spectrum 28a from the decoded signal spectrum 28; and the signal addition unit 11 for suppressing the deterioration components contained in the decoded signal spectrum 28 by adding the processed spectrum 19 to the decoded signal spectrum 28 from which the transformed decoded signal spectrum 28a is subtracted by the signal subtraction unit 22.

Since the signal processing unit 4 is configured in such a manner as to subtract the transformed decoded signal spectrum 28a from the decoded signal spectrum 28 and to add the processed spectrum 19, it offers an advantage of being able to further improve the subjective quality while suppressing the noise feeling of the output signal 6 in addition to the advantages described in the foregoing embodiment 5.

Incidentally, although the foregoing embodiment 6 carries out the addition processing of the signal addition unit 11 after the subtraction processing of the signal subtraction unit 22 as shown in FIG. 9, it goes without saying that the order can be reversed. In other words, it can subtract the transformed noise suppressed spectrum 28a after adding the processed spectrum 19 to the noise suppressed spectrum 28, offering the same advantage.

In addition, although the foregoing embodiment 6 has a configuration in which the voice decoder 200 includes the amplitude smoothing unit 12, a configuration is also possible which removes the amplitude smoothing unit 12 and omits the amplitude smoothing processing.

In addition, although the foregoing embodiment 6 employs the voice/noise decision unit 9 and noise spectrum update unit 10 for estimating the estimated noise spectrum 17, a means for obtaining the noise spectrum is not limited to the configuration as in the foregoing embodiment 1. For example, a method can also be employed which obviates the voice/noise decision unit 9 by greatly reducing the update speed of the noise spectrum, or which does not carry out the estimation of the estimated noise spectrum 17 from the input signal 1, but performs the analysis/estimation separately from the input signal for the noise estimation, to which only noise is input.

### Embodiment 7

The foregoing embodiments 5 and 6 are configured in such a manner as to employ, in the processing of the processed component calculating unit 14 in the signal transform unit 13, the fixed value in the frequency axis direction as the prescribed value to be multiplied for the individual frequencies of the estimated noise spectrum 17. As for the prescribed value to be multiplied for the individual frequencies of the estimated noise spectrum 17, the present embodiment has a configuration of weighting in the frequency axis direction such as assigning a large value to a low frequency and a small value to a high frequency. A configuration of the voice decoder 200 of the present embodiment is the same in a drawing as the configuration of the voice decoder 200 of the foregoing embodiment 5 shown in FIG. 8 or that of the embodiment 6 shown in FIG. 9, and differs only in the processing of the processed component calculating unit 14.

Incidentally, as for the weighting coefficients to be used for the frequency weighting, the processed component calculating unit 14 can selects them from one or more tables (which are an array of constants when described in a program) in accordance with the type of the voice encoding method or the liking of a user. Alternatively, it can define a function in advance which takes in a spectrum slope that can be calculated from the noise power or from the ratio between the low-frequency component power and the high-frequency component power of the estimated noise spectrum 17 and which generates and outputs the weighting coefficients, and can generate the weighting coefficient from the function for each frame to be successively applied.

According to the present embodiment 7, the processed component calculating unit 14 assigns weights in the frequency direction to the prescribed value to be multiplied for the individual frequencies of the estimated noise spectrum 17. Accordingly, in addition to the advantages described in the foregoing embodiments 5 and 6, it offers an advantage of being able to improve the subjective quality for the signal whose degree of deterioration varies in the frequency direction.

### Embodiment 8

Although the foregoing embodiment 1 is configured in such a manner as to generate the processed spectrum 19 by the signal processing unit 4 in accordance with the ratio based on the estimated noise spectrum 17 and the noise suppressed spectrum 18, the present embodiment has a configuration of controlling the phase disturbance width of the noise suppressed spectrum 18 in accordance with the ratio based on the estimated noise spectrum 17 and the noise suppressed spectrum 18.

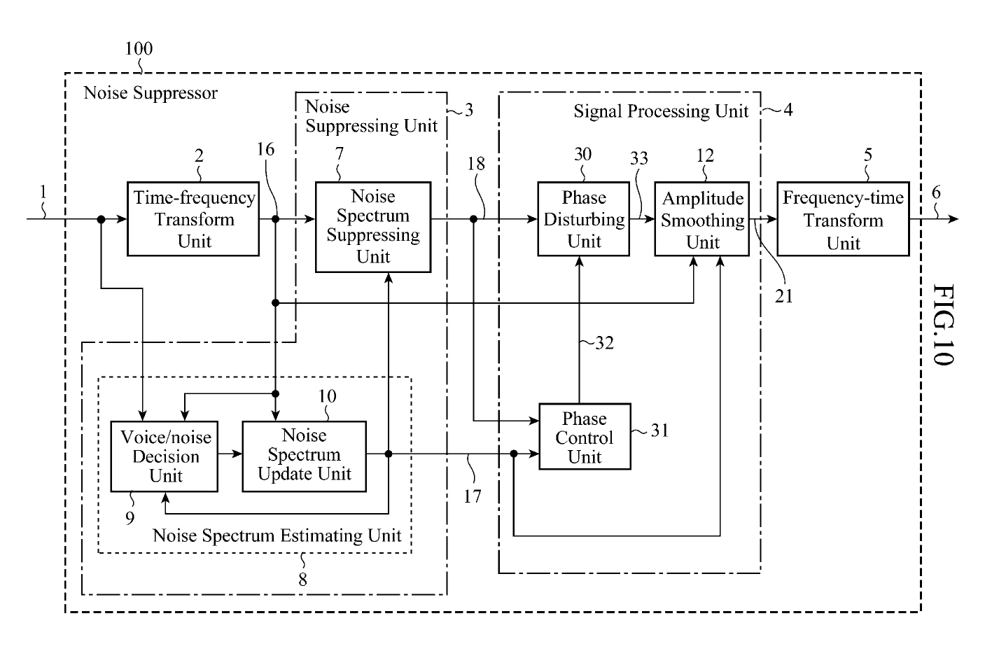

FIG. 10 shows an overall configuration of the noise suppressor 100 of the present embodiment. Being different from the signal processing unit 4 of the foregoing embodiment shown in FIG. 1, the signal processing unit 4 of the noise suppressor 100 shown in FIG. 10 comprises a phase disturbing unit 30, a phase control unit 31 and the amplitude smoothing unit 12. Incidentally, in FIG. 10, the same or like components to those of FIG. 1 are designated by the same reference numerals and their description will be omitted.

Receiving the noise suppressed spectrum 18 and estimated noise spectrum 17, the phase control unit 31 calculates, for example, the SN ratio between the noise suppressed spectrum 18 and the estimated noise spectrum 17 for the individual frequencies (the spectral SN ratio when denoting the noise suppressed spectrum 18 by S and the estimated noise spectrum 17 by N). Subsequently, the phase control unit 31 calculates a phase control signal 32 for controlling the phase disturbance width in accordance with the spectral SN ratio calculated, and supplies to the phase disturbing unit 30.

As a control method of the phase disturbance range, there is a method, for example, which controls in such a manner as to increase the phase disturbance range when the spectral SN ratio is small, and to decrease the range when the spectral SN ratio is large. As a setting method of the phase control signal 32 for designating the phase disturbance range, there is a method, for example, which stores a plurality of prescribed values corresponding to the spectral SN ratios in a table or the like, and which causes the phase control unit 31 to output the prescribed value corresponding to the spectral SN ratio on the table closest to the calculated spectral SN ratio as the phase control signal 32. Alternatively, it can define a prescribed function in advance which takes in the spectral SN ratio and outputs the phase control signal 32, and calculate the phase control signal 32 by the phase control unit 31 using the function. Regardless of the method used, it can be adjusted in advance in accordance with the type of the noise, the noise suppression method, the degree of the deterioration or the liking of the user.

In addition, in the control of the phase disturbance range, the phase control unit 31 can assign weights in the frequency axis direction such as increasing the disturbance range as the frequency becomes higher and stopping the phase disturbance in the low-frequency range. The phase control unit 31 can select the weighting coefficients used for the frequency weighting from one or more tables (which are an array of constants when described in a program) in accordance with the liking of a user. Alternatively, it can define a function in advance which takes in a spectrum slope that can be calculated from the noise power or from the ratio between the low-frequency component power and the high-frequency component power of the estimated noise spectrum 17 and which generates and outputs the weighting coefficients, and can generate the weighting coefficients from the function for each frame to be successively applied.

Incidentally, although the spectral SN ratio exemplifies a control factor of the phase disturbance range described above to simplify the explanation, the configuration is not essential. For example, it is also possible to employ as the control factor the ratio between the whole band power of the noise suppressed spectrum 18 and the whole band power of the estimated noise spectrum 17, and the spectrum slope that can be calculated from the ratio between the low-frequency component power and the high-frequency component power of the estimated noise spectrum 17, and to use a combination of them. Adding these control factors enables the phase control unit 31 to control the phase disturbance range more accurately, thereby being able to improve the subjective quality.

The phase disturbing unit 30 performs the phase disturbance of the noise suppressed spectrum 18 according to the phase control signal 32 for controlling the phase disturbance width the phase control unit 31 outputs, and outputs as a phase disturbance spectrum 33. Incidentally, employing the phase disturbing unit 15 described in the foregoing embodiment 1 shown in FIG. 1 instead of the phase disturbing unit 30 can achieve the same advantages.

The amplitude smoothing unit 12 performs on the phase disturbance spectrum 33 supplied from the phase disturbing unit 30 the smoothing processing of the amplitude components of the spectrum for the individual frequencies, and supplies the smoothed spectrum to the frequency-time transform unit 5 as the smoothed noise suppressed spectrum 21. Incidentally, as for the configuration of the amplitude smoothing unit 12 and its processing and smoothing control method, those similar to those of the embodiment 1 can be used. As for the individual parameters, they can be adjusted in advance in accordance with the type of the noise suppression method or the degree of deterioration of the signal, for example.

In addition, to a degree that has no effect on the voice signal (1 dB in amplitude, for example), the amplitude smoothing unit 12 can superpose, on the spectral components after the smoothing processing, artificially generated pseudo-noise such as noise with Hoth spectrum characteristics, Brown noise, or noise obtained by providing white noise with frequency characteristics (like a slope) of the noise spectrum in the input signal.

According to the present embodiment 8, the noise suppressor 100 is configured in such a manner that when the signal processing unit 4 performs the prescribed processing on the noise suppressed spectrum 18 deteriorated through the noise suppression or the like, it carries out phase disturbance to make the deterioration components in the noise suppressed spectrum 18 subjectively imperceptible according to the frequency component values of the noise suppressed spectrum 18 which is the input signal and according to the frequency component values of the estimated noise spectrum 17. Accordingly, the voice/noise interval decision, which is necessary in the conventional method, becomes unnecessary. As a result, it offers an advantage of being able to improve the subjective quality without the echo feeling or noise feeling due to the interval decision error.

In addition, the signal processing unit 4 is configured in such a manner as to perform smooth processing for the individual spectral components in the frequency domain. Accordingly, even for the voice signal into which the car noise whose noise power is concentrated in the low-frequency range is mixed, for example, since it can process the deterioration components without processing the voice components in the high-frequency range while subjectively improving the deterioration feeling of the noise in the low-frequency range, it offers an advantage of being able to further improve the subjective quality.

In addition, the signal processing unit 4 is configured in such a manner as to perform the processing for the individual spectral components in accordance with both the noise suppressed spectrum 18 which is the input signal and the estimated noise spectrum 17. Accordingly, it can perform the processing control in accordance with the individual spectral components. Thus, it offers an advantage of being able to improve the subjective quality even for the signal with the deterioration components occurring locally in a particular band.

In addition, as the processing of the signal processing unit 4, it is configured in such a manner as to smooth the amplitude spectral components and to disturb the phase spectral components. Accordingly, as for the artificial amplitude components and phase components the deterioration components have, it can appropriately suppress unstable behavior of the components and provide disturbance, thereby offering an advantage of being able to further improve the subjective quality.

Incidentally, although the foregoing embodiment 8 has a configuration in which the noise suppressor 100 includes the amplitude smoothing unit 12, a configuration is also possible which does not include the amplitude smoothing unit 12 and omits the amplitude smoothing processing.

In addition, although the foregoing embodiment 8 employs the voice/noise decision unit 9 and noise spectrum update unit 10 for estimating the estimated noise spectrum 17, a means for obtaining the noise spectrum is not limited to the configuration as in the foregoing embodiment 1. For example, a method can also be employed which obviates the voice/noise decision unit 9 by greatly reducing the update speed of the noise spectrum, or which does not carry out the estimation of the estimated noise spectrum 17 from the decoded signal 27, but performs the analysis/estimation separately from the input signal for the noise estimation, to which only noise is input.

In addition, although the foregoing embodiment 8 performs the noise suppression in the frequency domain, the configuration is not essential. Combining the configuration of the foregoing embodiment 8 with that of the foregoing embodiment 4 enables the time domain noise suppression. To be concrete, the signal processing unit 4 of the embodiment 4 can be replaced by the signal processing unit 4 of the embodiment 8.

In the case of the configuration, regardless of the frequency domain or time domain as the technique of the noise suppression, it can offer an advantage of being able to improve the subjective quality.

### Embodiment 9

As in the foregoing embodiment 8, the voice decoder 200 of the foregoing embodiment 5 can be modified in such a manner that the signal processing unit 4 controls, instead of generating the processed spectrum 19 in accordance with the ratio based on the decoded signal spectrum 28 and the estimated noise spectrum 17, the phase disturbance width of the decoded signal spectrum 28 in accordance with the ratio based on the decoded signal spectrum 28 and the estimated noise spectrum 17.

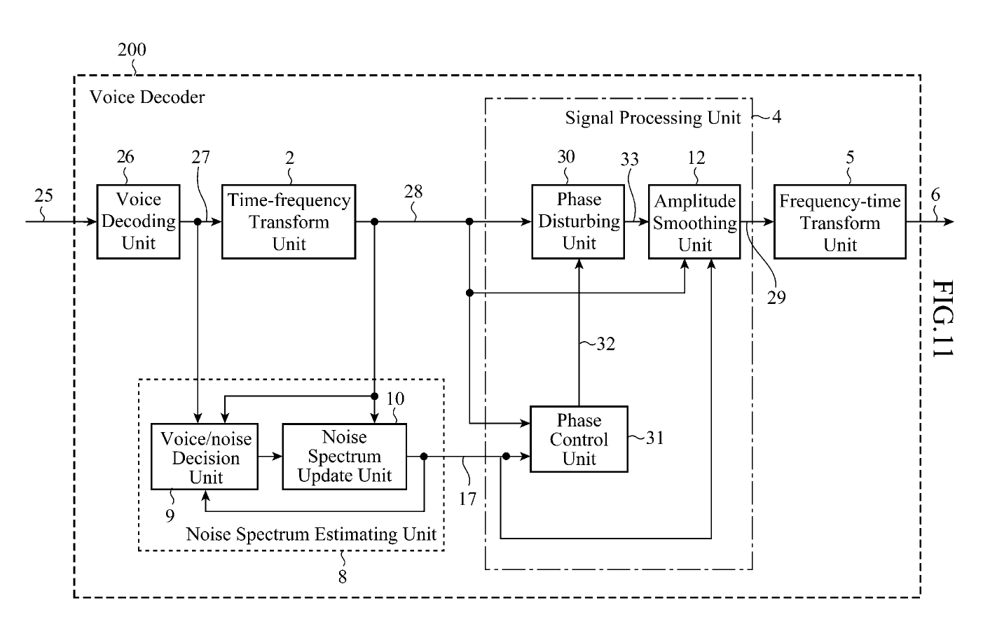

FIG. 11 shows an overall configuration of the voice decoder 200 of the present embodiment. Being different from the signal processing unit 4 of the foregoing embodiment 5, the signal processing unit 4 of the voice decoder 200 shown in FIG. 11 comprises the phase disturbing unit 30, phase control unit 31 and amplitude smoothing unit 12. In FIG. 11, the same or like components to those of FIG. 5 or FIG. 8 are designated by the same reference numerals and their description will be omitted.

Receiving the decoded signal spectrum 28 and estimated noise spectrum 17, the phase control unit 31 calculates the SN ratios between the decoded signal spectrum 28 and estimated noise spectrum 17 for individual frequencies (spectral SN ratios between the decoded signal spectrum 28 as S and the estimated noise spectrum 17 as N). Subsequently, the phase control unit 31 calculates the phase control signal 32 for controlling the phase disturbance width in accordance with the spectral SN ratio calculated, and supplies to the phase disturbing unit 30.

As a control method of the phase disturbance range, there is a method, for example, which controls in such a manner as to increase the phase disturbance range when the spectral SN ratio is small, and to decrease the range when the spectral SN ratio is large. As for the setting method of the phase control signal 32 for designating the phase disturbance range, the control of the disturbance range and the control factor, techniques similar to the processing of the embodiment 8 can be used, and they can be adjusted in advance in accordance with the type of the voice encoding method, the degree of deterioration or the liking of the user.

The phase disturbing unit 30 performs the phase disturbance of the decoded signal spectrum 28 in accordance with the phase control signal 32 the phase control unit 31 outputs, and produces as the phase disturbance spectrum 33. Incidentally, employing the configuration of the phase disturbing unit 15 described in the foregoing embodiment 1 shown in FIG. 1 instead of the phase disturbing unit 30 can also achieve similar advantages.

The amplitude smoothing unit 12 performs on the phase disturbance spectrum 33 supplied from the phase disturbing unit 30 the smoothing processing of the amplitude components of the spectrum for the individual frequencies, and supplies the smoothed spectrum to the frequency-time transform unit 5 as the smoothed decoded signal spectrum 29. Incidentally, as for the configuration of the amplitude smoothing unit 12 and its processing and smoothing control method, those similar to those of the foregoing embodiment 5 can be used. As for the individual parameters, they can be adjusted in advance in accordance with the type of the voice encoding method or the degree of deterioration of the signal, for example.

In addition, to a degree that has no effect on the voice signal (1 dB in amplitude, for example), the amplitude smoothing unit 12 can superpose, on the spectral components after the smoothing processing, artificially generated pseudo-noise such as noise with Hoth spectrum characteristics, Brown noise, or noise obtained by providing white noise with frequency characteristics (like a slope) of the noise spectrum in the input signal.

According to the present embodiment 9, the voice decoder 200 is configured in such a manner that when the signal processing unit 4 performs the prescribed processing on the decoded signal spectrum 28 deteriorated through the voice encoding, it carries out phase disturbance to make the deterioration components in the decoded signal spectrum 28 subjectively imperceptible according to the frequency component values of the decoded signal spectrum 28 which is the input signal and according to the frequency component values of the estimated noise spectrum 17. Accordingly, the voice/noise interval decision, which is necessary in the conventional method, becomes unnecessary. As a result, it offers an advantage of being able to improve the subjective quality without the echo feeling or noise feeling due to the interval decision error.

In addition, the signal processing unit 4 is configured in such a manner as to perform smooth processing for the individual spectral components in the frequency domain. Accordingly, even for the voice signal into which the car noise whose noise power is concentrated in the low-frequency range is mixed, for example, since it can process the deterioration components without processing the voice components in the high-frequency range while subjectively improving the deterioration feeling of the noise in the low-frequency range, it offers an advantage of being able to further improve the subjective quality.

In addition, the signal processing unit 4 is configured in such a manner as to perform the processing for the individual spectral components in accordance with both the decoded signal spectrum 28 which is the input signal and the estimated noise spectrum 17. Accordingly, it can perform the processing control in accordance with the individual spectral components. Thus, it offers an advantage of being able to improve the subjective quality even for the signal with the deterioration components occurring locally in a particular band.

In addition, as the processing of the signal processing unit 4, it is configured in such a manner as to smooth the amplitude spectral components and to disturb the phase spectral components. Accordingly, as for the artificial amplitude components and phase components the deterioration components have, it can appropriately suppress unstable behavior of the components and provide disturbance, thereby offering an advantage of being able to further improve the subjective quality.

Incidentally, although the foregoing embodiment 9 has a configuration in which the voice decoder 200 includes the amplitude smoothing unit 12, a configuration is also possible which does not include the amplitude smoothing unit 12 and omits the amplitude smoothing processing.

In addition, although the foregoing embodiment 9 employs the voice/noise decision unit 9 and noise spectrum update unit 10 for estimating the estimated noise spectrum 17, a means for obtaining the noise spectrum is not limited to the configuration as in the foregoing embodiment 1. For example, a method can also be employed which obviates the voice/noise decision unit 9 by greatly reducing the update speed of the noise spectrum, or which does not carryout the estimation of the estimated noise spectrum 17 from the decoded signal 27, but performs the analysis/estimation separately from the input signal for the noise estimation, to which only noise is input.

### Embodiment 10

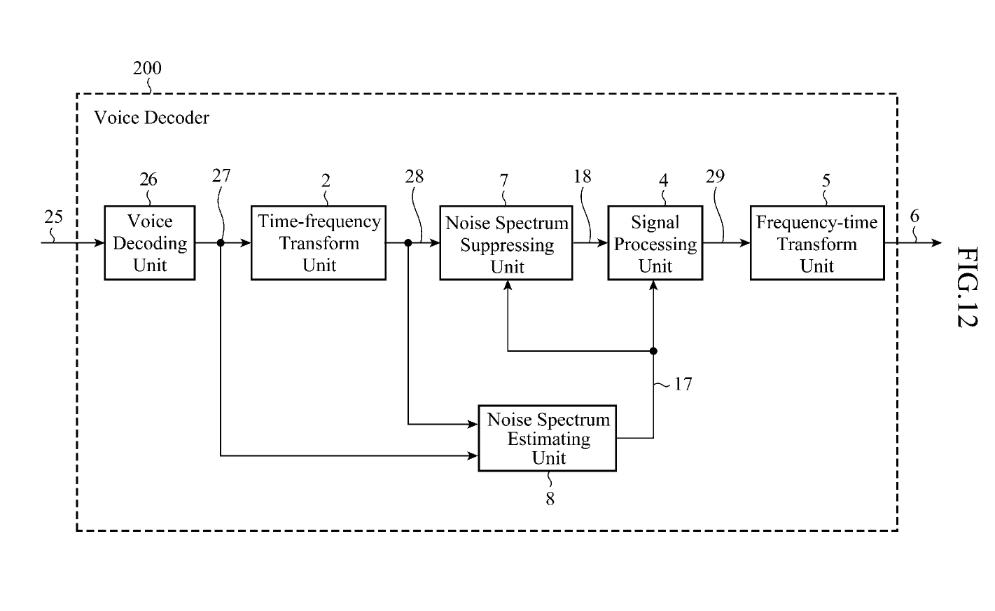

Although the foregoing embodiments 5-7 and 9 have a configuration in which the signal processing unit 4 performs its processing by designating the decoded signal spectrum 28 as a processing target, a configuration is also possible in which the signal processing unit 4 carries out the signal processing after the noise spectrum suppressing unit 7 performs the noise suppression of the decoded signal 27 as shown in FIG. 12. FIG. 12 is a diagram showing an overall configuration of the voice decoder 200 of the present embodiment. Although FIG. 12 shows a configuration comprising the noise spectrum suppressing unit 7 for performing the noise suppression, a configuration is also possible which comprises the noise suppression filter unit 23 and time-frequency transform unit 24 (FIG. 7) instead of the noise spectrum suppressing unit 7. Incidentally, in FIG. 12, the same or like components to those of FIGS. 1-11 are designated by the same reference numerals and their description will be omitted.

As the noise suppression in the present embodiment, it is possible to employ the noise suppression method in the frequency domain by the noise spectrum suppressing unit 7 as described in the foregoing embodiment 1, or the noise suppression method in the time domain by the noise suppression filter unit 23 as described in the foregoing embodiment 4. In this case, although the decoded signal spectrum 28 suffers from the deterioration involved in the noise suppression anew in addition to the deterioration involved in the voice encoding, it is only necessary to appropriately adjust the control method of the signal transform unit 13, amplitude smoothing unit 12 and phase control unit 31 in the signal processing unit 4, which are not shown in the drawing, and a variety of parameters in accordance with the degree of deterioration.

In addition, although the noise suppression is explained as an example of the processing following after the voice decoding unit 26, it can be replaced by other signal processing such as post-filter processing like formant emphasis and acoustic masking, and amplitude dynamic range compression.

According to the present embodiment 10, it can process the signal including the deterioration components other than those occurring from the voice encoding to the subjectively desirable signal, thereby offering an advantage of being able to improve the subjective quality.

### Embodiment 11

Although the foregoing embodiments 1-10 are configured in such a manner that the time-frequency transform unit 2 calculates the spectral components by an FFT, and the frequency-time transform unit 5 returns the spectral components passing through the processing to the time domain signal by the inverse FFT processing, a configuration is also possible which performs processing on the individual outputs of the bandpass filters instead of the FFT, and obtains the output signal by adding the signals of the individual bands, or which employs a transform function such as a wavelet transform.

According to the present embodiment 11, it can achieve similar advantages to those described in the embodiments 1-10 with a configuration without using a Fourier transform.

Incidentally, in the foregoing embodiments 1-11, it is also possible to employ the configuration with the phase disturbing unit 30 (and phase control unit 31) instead of the configuration with the phase disturbing unit 15, and to employ the configuration with the phase disturbing unit 15 instead of the configuration with the phase disturbing unit 30 (and phase control unit 31).

### INDUSTRIAL APPLICABILITY

As described above, the noise suppressor and voice decoder in accordance with the present invention suppress noise other than the intended signal such as the voice/acoustic signal, thereby achieving the noise suppressor and voice decoder capable of improving the sound quality of voice recognition rate. Accordingly, they are suitable for applications to a voice communication system such as a mobile phone and intercom, a hands-free telephone system, a video conferencing system, a monitoring system, a voice storage system, and a voice recognition system, which are used in various noise environment.

What is claimed is:

1. A noise suppressor comprising:
a time-frequency transform unit for transforming an input signal to an input signal spectrum composed of frequency components;
a noise spectrum estimating unit for estimating an estimated noise spectrum from the input signal;
a noise spectrum suppressing unit for performing noise suppression of the input signal spectrum according to the estimated noise spectrum and for generating a noise suppressed spectrum;
a signal transform unit for generating a processed spectrum by transforming and smoothing the noise suppressed spectrum in accordance with a ratio based on the noise suppressed spectrum and the estimated noise spectrum; and
a signal addition unit for suppressing deterioration components included in the noise suppressed spectrum by adding the processed spectrum to the noise suppressed spectrum.

2. The noise suppressor according to claim 1, wherein
the signal transform unit generates the processed spectrum weighted in a frequency axis direction.

3. A noise suppressor comprising:
a time-frequency transform unit for transforming an input signal to an input signal spectrum composed of frequency components;
a noise spectrum estimating unit for estimating an estimated noise spectrum from the input signal;
a noise spectrum suppressing unit for performing noise suppression of the input signal spectrum according to the estimated noise spectrum and for generating a noise suppressed spectrum;
a signal transform unit for generating a transformed noise suppressed spectrum by transforming the noise suppressed spectrum in accordance with a ratio based on the noise suppressed spectrum and the estimated noise spectrum and for generating a processed spectrum by smoothing the transformed noise suppressed spectrum;
a signal subtraction unit for subtracting the transformed noise suppressed spectrum from the noise suppressed spectrum; and
a signal addition unit for suppressing deterioration components included in the noise suppressed spectrum by adding the processed spectrum to the noise suppressed spectrum from which the transformed noise suppressed spectrum is subtracted by the signal subtraction unit.

4. The noise suppressor according to claim 3, wherein
the signal transform unit generates the processed spectrum weighted in a frequency axis direction.

5. A noise suppressor comprising:
a time-frequency transform unit for transforming an input signal to an input signal spectrum composed of frequency components;
a noise spectrum estimating unit for estimating an estimated noise spectrum from the input signal;
a noise spectrum suppressing unit for performing noise suppression of the input signal spectrum according to the estimated noise spectrum and for generating a noise suppressed spectrum; and
a phase disturbing unit for disturbing a phase of the noise suppressed spectrum at a degree corresponding to a ratio based on the noise suppressed spectrum and the estimated noise spectrum.

6. The noise suppressor according to claim 5, wherein
the phase disturbing unit obtains the degree of phase disturbance weighted in a frequency axis direction.

7. A voice decoder comprising:
a voice decoding unit for generating a decoded signal by decoding given code data;
a time-frequency transform unit for transforming the decoded signal to a decoded signal spectrum composed of frequency components;
a noise spectrum estimating unit for estimating an estimated noise spectrum from the decoded signal;
a signal transform unit for generating a processed spectrum by transforming and smoothing the decoded signal spectrum in accordance with a ratio based on the decoded signal spectrum and the estimated noise spectrum; and
a signal addition unit for suppressing deterioration components included in the decoded signal spectrum by adding the processed spectrum to the decoded signal spectrum.

8. The voice decoder according to claim 7, wherein
the signal transform unit generates the processed spectrum weighted in a frequency axis direction.

9. A voice decoder comprising:
a voice decoding unit for generating a decoded signal by decoding given code data;
a time-frequency transform unit for transforming the decoded signal to a decoded signal spectrum composed of frequency components;
a noise spectrum estimating unit for estimating an estimated noise spectrum from the decoded signal;
a signal transform unit for generating a transformed decoded signal spectrum by transforming the decoded signal spectrum in accordance with a ratio based on the decoded signal spectrum and the estimated noise spectrum and for generating a processed spectrum by smoothing the transformed decoded signal spectrum;
a signal subtraction unit for subtracting the transformed decoded signal spectrum from the decoded signal spectrum; and
a signal addition unit for suppressing deterioration components included in the decoded signal spectrum by adding the processed spectrum to the decoded signal spectrum from which the transformed decoded signal spectrum is subtracted by the signal subtraction unit.

10. The voice decoder according to claim 9, wherein
the signal transform unit generates the processed spectrum weighted in a frequency axis direction.

11. A voice decoder comprising:
a voice decoding unit for generating a decoded signal by decoding given code data;
a time-frequency transform unit for transforming the decoded signal to a decoded signal spectrum composed of frequency components;
a noise spectrum estimating unit for estimating an estimated noise spectrum from the decoded signal; and
a phase disturbing unit for disturbing a phase of the decoded signal spectrum at a degree corresponding to a ratio based on the decoded signal spectrum and the estimated noise spectrum.

12. The voice decoder according to claim 11, wherein
the phase disturbing unit obtains the degree of the phase disturbance weighted in a frequency axis direction.
